(19) United States
(12) Patent Application Publication
(10) Pub. No.: US 2014/0354734 A1
(43) Pub. Date: Dec. 4, 2014

(54) NON-CONTACT BIO-PRINTING

(71) Applicant: The Regents of the University of California, Oakland, CA (US)

(72) Inventors: Tingrui Pan, Woodland, CA (US); Yuzhe Ding, Davis, CA (US); Eric Huang, Davis, CA (US); Kit Lam, Davis, CA (US)

(73) Assignee: The Regents of the University of California, Oakland, CA (US)

(21) Appl. No.: 14/295,083

(22) Filed: Jun. 3, 2014

Related U.S. Application Data
(60) Provisional application No. 61/831,071, filed on Jun. 4, 2013.

(51) Int. Cl. B41J 3/00

(52) U.S. Cl. CPC B41J 3/00
USPC 347/54

(57) ABSTRACT

A microfluidic electronic device is disclosed. This microfluidic electronic device may include a separate actuator mechanism from a microfluidic cartridge. The microfluidic cartridge may include a fluid reservoir coupled to a nozzle by a channel, where the fluid reservoir holds a fluid with a solvent and a material in solution, and the microfluidic cartridge may be remateably coupled to the microfluidic electronic device. During operation of the microfluidic electronic device, the microfluidic cartridge supplies fluid to the nozzle via the channel, and the actuator mechanism drives droplets from the nozzle without contact between the actuator mechanism and the fluid. Furthermore, the droplets may be driven from the nozzle onto a substrate without contact between the substrate and the nozzle, and a positioning mechanism in the microfluidic electronic device may accurately position the nozzle relative to the substrate.

### CROSS-REFERENCE TO RELATED APPLICATION

This application claims priority under 35 U.S.C. §119(e) to U.S. Provisional Application Ser. No. 61/831,071, entitled “Multiplexed Microfluidic-Ribbon Printer,” by Tingrui Pan, Yuzhe Ding, Eric Huang and Kit Lam, Attorney Docket Number UC12-691-2PSP, filed on Jun. 4, 2013, the contents of which are herein incorporated by reference.

### BACKGROUND

1. Field

The present disclosure generally relates to a technique for non-contact printing. More specifically, the present disclosure relates to a technique for non-contact printing using a printer with a separate microfluidic cartridge and printer head.

2. Related Art

Researchers are presently investigating the printing of biological materials, such as deoxyribonucleic acid (which is sometimes referred to as ‘bio-printing’). Bio-printing may allow test samples to be fabricated on a substrate. However, the current techniques (such as photolithography, screen printing and inkjet printing) used for bio-printing are often difficult and expensive. In particular, the wet-chemistry processing (e.g., applying photoresist, developer, organic solvent) and ultraviolet exposure during photolithography can degrade biological materials. In addition, the use of clean-room conditions is often expensive. Alternatively, techniques that involve contact printing (such as screen printing) often result in contamination, and it can be difficult to align the material with a substrate during the bio-printing.

In principle, non-contact inkjet printing can avoid these problems. In practice, however, the integrated cartridge and printer head used in inkjet printers is expensive and it is often difficult to modify these integrated cartridges to accommodate different solvents and/or to optimize the printing process.

Hence, what is needed is a technique for printing biological materials without the problems described above.

### SUMMARY

The described embodiments include an electronic device (such as a microfluidic electronic device). This electronic device includes: an actuator mechanism; and a cartridge (such as a microfluidic cartridge), separate from the actuator mechanism, with a fluid reservoir coupled to a nozzle by a channel, where the cartridge is remateably coupled to the electronic device, and where the fluid reservoir holds a fluid with a solvent and a material in solution. During operation of the electronic device, the cartridge supplies fluid to the nozzle via the channel, and the actuator mechanism drives droplets from the nozzle without contact between the actuator mechanism and the fluid.

For example, the actuator mechanism may drive the droplets using a pin that pushes on a membrane, and the pin may be actuated by: an electrostatic force, an electromagnetic force, air pressure, and/or a piezoelectric material.

Furthermore, the electronic device may include a substrate. During operation of the electronic device, the droplets may be driven from the nozzle onto the substrate without contact between the substrate and the nozzle. Additionally, the electronic device may include a positioning mechanism that positions the nozzle relative to the substrate.

Note that a geometry of the channel and/or the nozzle may correspond to a desired size of the droplets. Thus, the use of a separate cartridge may allow optimization of the geometry.

Moreover, the solvent may include: water and/or an organic solvent. Furthermore, the material may include: deoxyribonucleic acid, ribonucleic acid, a protein, a cell, and/or a pharmacological agent.

In some embodiments, the cartridge includes multiple layers made of a polymer, such as a silicone.

Another embodiment provides the cartridge for use with the electronic device.

Another embodiment provides a method that includes at least some of the operations performed by the electronic device. During operation of the electronic device, the fluid reservoir provides, via the channel, the fluid with the solvent and the material in solution to the nozzle in the cartridge. Then, using the actuator mechanism, the electronic device drives droplets from the nozzle without contact between the actuator mechanism and the fluid, where the actuator mechanism is separate from the cartridge, and where the cartridge is remateably coupled to the electronic device.

### BRIEF DESCRIPTION OF THE FIGURES

FIG. 1 is a block diagram illustrating a microfluidic electronic device in accordance with an embodiment of the present disclosure.

FIG. 2 is a drawing illustrating operation of the microfluidic electronic device of FIG. 1 in accordance with an embodiment of the present disclosure.

FIG. 3 is a block diagram illustrating a microfluidic cartridge for use in the microfluidic electronic device of FIG. 1 in accordance with an embodiment of the present disclosure.

FIG. 4 is a flow diagram illustrating a method for non-contact printing in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of a microfluidic electronic device (such as a printer), a microfluidic cartridge for use with the microfluidic electronic device, and a non-contact printing technique are described. The microfluidic electronic device may include a separate actuator mechanism from the microfluidic cartridge. The microfluidic cartridge may include a fluid reservoir coupled to a nozzle by a channel, where the fluid reservoir holds a fluid with a solvent and a material in solution, and the microfluidic cartridge may be remateably coupled to the microfluidic electronic device. During operation of the microfluidic electronic device, the microfluidic cartridge supplies fluid to the nozzle via the channel, and the actuator mechanism drives droplets from the nozzle without contact between the actuator mechanism and the fluid. Furthermore, the droplets may be driven from the nozzle onto a substrate without contact between the substrate and the nozzle, and a positioning mechanism in the microfluidic electronic device may accurately position the nozzle relative to the substrate.

By separating the microfluidic cartridge from the actuator mechanism, the microfluidic cartridge may have a low cost, and may be readily optimized or modified based on different fluids and/or the surface chemistry. For example, the geometry of the channel and/or the nozzle may be modified based on an amount of material to be deposited on the substrate. Furthermore, the use of non-contact printing (i.e., no contact between the actuator mechanism and the fluid, and no contact between the nozzle and the substrate) may help prevent contamination of the fluid and/or the material. In addition, the positioning mechanism may allow the droplets to be positioned or disposed on the substrate with highly precise alignment. This may ensure that the printing is repeatable. Consequently, the microfluidic electronic device may reduce the cost, and increase the quality and/or the accuracy of bio-printing the material on the substrate.

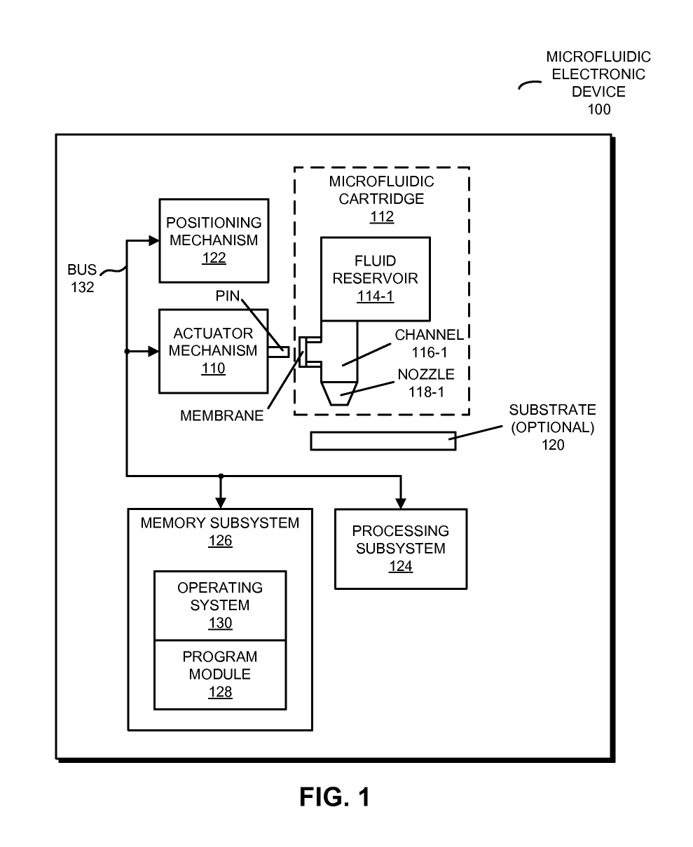

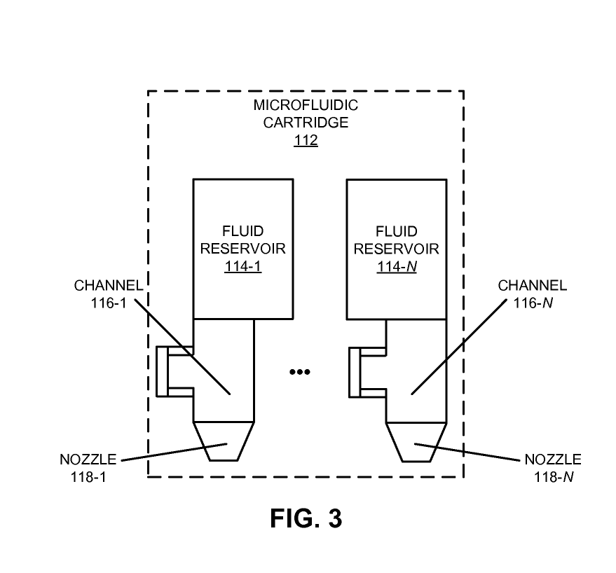

We now describe embodiments of the microfluidic electronic device. FIG. 1 presents a block diagram illustrating a microfluidic electronic device 100 with an actuator mechanism 110 (such as an impact matrix head from an impact or a dot-matrix printer) and microfluidic cartridge 112, which is separate from actuator mechanism 110. As described further below with reference to FIG. 3, microfluidic cartridge 112 may include a fluid reservoir 114-1 coupled to at least a nozzle 118-1 by at least a channel 116-1 (thus, in some embodiments there are multiple nozzles, such as 24 nozzles, which may allow printing of multiple droplets in parallel). This fluid reservoir may hold a fluid with a solvent and a material in solution. For example, the solvent may include: water and/or an organic solvent (such as dimethyl sulfoxide or dimethylformamide). Moreover, the material may include: deoxyribonucleic acid (DNA), ribonucleic acid (RNA), a protein, a cell, and/or a pharmacological agent (such as a drug and/or a small molecule). Furthermore, microfluidic cartridge 112 may be remateably coupled to microfluidic electronic device 100. In particular, microfluidic cartridge 112 may be removable, so that microfluidic electronic device 100 may be used with different types of microfluidic cartridges (i.e., the microfluidic cartridges may be interchangeable).

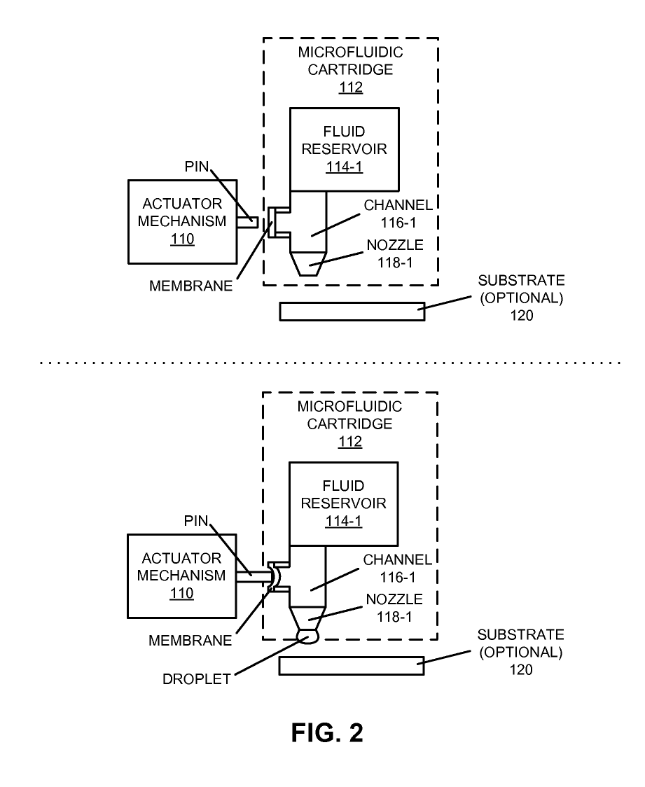

Note that a geometry or dimension of channel 116-1 (such as a width of channel 116-1) and/or nozzle 118-1 (such as a diameter of nozzle 118-1) may correspond to a desired size of the droplets. For example, the size of nozzle 118-1 may be changed based on the amount of material to be deposited on optional substrate 120 (which may be included in or separate from microfluidic electronic device 100). In particular, the printed droplet volume is related to the geometric properties of channel 116-1 and nozzle 118-1 by

$$\frac{3 π {ld}^{4}}{64 {twh}^{3}} \cdot S \cdot Δ H ,$$

where l is the length of channel 116-1, w is the width of channel 116-1, h is the height channel 116-1, d is the diameter of nozzle 118-1, t is the length of nozzle 118-1, S is the tip area of a pin that pushes on a deformable membrane to produce a droplet (which is described further below with reference to FIG. 2), and ΔH is the pin-induced membrane deflection. Thus, the use of a separate microfluidic cartridge 112 may allow customization or optimization of the geometry so that different types of microfluidic cartridges can be fabricated for use with different fluids, different surface chemistry, etc., so that microfluidic electronic device 100 can be used with an arbitrary fluid. In addition, because actuator mechanism 110 (which may include relatively expensive components, such as a printer head) and microfluidic cartridge 112 are separate, the cost of microfluidic cartridge 112 may be reduced significantly. This may allow microfluidic cartridge 112 to be disposable.

As shown in FIG. 2, which presents a drawing illustrating operation of microfluidic electronic device 100, microfluidic cartridge 112 may supply fluid to nozzle 118-1 via channel 116-1, and actuator mechanism 110 may drive droplets from nozzle 118-1 without contact between actuator mechanism 110 and the fluid. For example, actuator mechanism 110 may drive the droplets using the pin that pushes on the deformable membrane, and the pin may be actuated by: an electrostatic force, an electromagnetic force, air pressure, and/or a piezoelectric material. (Alternatively, in some embodiments the droplets are driven out of nozzle 118-1 using thermal expansion based on a heater or heating mechanism proximate to channel 116-1.) Furthermore, the droplets may be driven from nozzle 118-1 onto optional substrate 120 without contact between optional substrate 120 and nozzle 118-1. This non-contact printing technique may avoid contamination of the fluid and/or optional substrate 120.

In addition, a positioning mechanism 122 (such as an x, y, and/or z translation stage, and/or a piezoelectric positioning mechanism) may position nozzle 118-1 relative to optional substrate 120 prior to the non-contact printing. This may allow the droplets to be accurately placed on optional substrate 120. For example, the position of the droplets on optional substrate 120 may be computer controlled with precise three-dimensional (3D) alignment, such as a misalignment of less than 10 μm.

Note that a wetting contrast-enabled self-alignment technique may be used to improve the alignment. In particular, hydrophilic agarose droplets as positioning anchors may be deposited on optional substrate 120 prior to consecutive printings. As a common matrix for cell culture, agarose gel is intrinsically hydrophilic and can be self-primed. When deposited onto a chemically inert polydimethylsiloxane (PDMS), the agarose droplet may retain its spherical shape. During the subsequent printing operations, the ejected aqueous droplets, once in contact with optional substrate 120, may autonomously move under the wettability gradient toward the agarose patterns.

In an exemplary embodiment, actuator mechanism 110 is a dot-matrix printer that is converted from contact printing to non-contact printing by having electromagnetically actuated pins strike a deformable membrane, which compresses channel 116-1 to drive droplets out of nozzle 118-1. This non-contact printing technique is sometimes referred to as ‘microfluidic impact printing.’

In this way, microfluidic electronic device 100 may provide: low-cost, high-throughput (such as up to 200 Hz), accurate, repeatable non-contact printing of arbitrary patterns. In addition, microfluidic electronic device 100 may reduce or eliminate crosstalk, and may be compatible with a wide variety of solvents in the fluid. Thus, microfluidic electronic device 100 may provide a versatile micro-patterning solution. The resulting micro-patterns printed on optional substrate 120 may be used in a wide variety of applications, including: DNA applications (such as gene expression, SNP genotyping, cancer diagnosis and treatment, genomics, agricultural, biotechnology, and drug discovery), lab-on-chip applications (such as drug discovery, genomics, diagnostics, proteomics, in-vitro diagnostic and point of care, and high-throughput screening), and/or protein microarray applications (such as expression profiling, proteomics, high-throughput screening, diagnostics, and drug discovery).

FIG. 3 presents a block diagram illustrating microfluidic cartridge 112. This microfluidic cartridge includes multiple layers made of an organic material (such as plastic) or a polymer, such as a silicone. For example, the microfluidic cartridge may be fabricated using PDMS. In an exemplary embodiment, microfluidic cartridge 112 includes five layers, including: an alignment/fitting structure to actuator mechanism 110 (FIG. 1), a spacer, a deformable membrane in contact with the pins during the printing, a channel layer, and one or more nozzles. Note that the alignment/fitting structure may allow the microfluidic microfluidic cartridge to be easily fitted and aligned to actuator mechanism 110 (FIG. 1) while the space determines the overall deformation caused by the striking pins. As the mechanically induced deformation increases, the hydrostatic pressure elevates accordingly inside channel 116-1, thus inducing flow motion toward nozzle 118-1. As the geometry of the orifices tapers, the flow accelerates along nozzle 118-1 and shoots out as a droplet at the nozzle opening, which will be deposited onto the target substrate (i.e., optional substrate 120 in FIG. 1).

In addition, microfluidic cartridge 112 may include multiple fluid reservoirs 114, channels 116 and nozzles 118. For example, there may be five instances of each, which may allow simultaneous printing of five different reagents or biological materials. (More generally, there may be N instances, where N is an integer.) Each of the associated fluid reservoirs and channels may include 0.6 μL. For printed droplets of 250 pL, microfluidic cartridge 112 may produce more than 2000 ejections with each loading. Note that microfluidic cartridge 112 may be fabricated using laser micromachining and oxygen-plasma bonding (such as 90 W for 30 s).

In an exemplary embodiment, the diameter of nozzle 118-1 is between 100-300 μm, the height of channel 116-1 is between 150-700 μm, and the deflection of the deformable membrane in actuator mechanism 110 (FIG. 1) is between 50-450 μm. Furthermore, the flow resistance of nozzle 118-1 may be larger (such as 15 times larger) than that of channel 116-1. In general, the printing resolution (i.e., the dimension of the printed droplets) when using microfluidic cartridge 112 is controlled by the geometry of the microfluidic cartridge 112, the solvent types, and the surface chemistry of the target substrate. For example, with a nozzle diameter of 0.1 mm, a channel height of 0.3 mm and a membrane deflection of 0.1 mm, an aqueous-based droplet having a diameter of approximately 0.08 mm can be printed on a PDMS substrate. The size of the droplet is typically not affected by the material in the solvent (e,g., cells, DNA, RNA, protein, a peptide, etc.), In addition, because most of the biological sample is dissolved in the solvent, and the usual solvents have similar viscosity, the printing resolution is not a significant function of the solvent used. However, the surface chemistry of the target substrate does affect the printing resolution. In particular, for water as the solvent (i.e., an aqueous-based solution), a hydrophobic substrate usually provides much better printing resolution than a hydrophilic substrate.

Referring back to FIG. 1, microfluidic electronic device 100 may include processing subsystem 124 and memory subsystem 126. Processing subsystem 124 includes one or more devices configured to perform computational operations. For example, processing subsystem 124 can include one or more microprocessors, application-specific integrated circuits (ASICs), microcontrollers, programmable-logic devices, and/or one or more digital signal processors (DSPs).

Memory subsystem 126 includes one or more devices for storing data and/or instructions for processing subsystem 124. For example, memory subsystem 126 can include dynamic random access memory (DRAM), static random access memory (SRAM), and/or other types of memory. In some embodiments, instructions for processing subsystem 124 in memory subsystem 126 include: one or more program modules or sets of instructions (such as program module 128 or operating system 130), which may be executed by processing subsystem 124. Note that the one or more computer programs may constitute a computer-program mechanism. Moreover, instructions in the various modules in memory subsystem 126 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 124.

In addition, memory subsystem 126 can include mechanisms for controlling access to the memory. In some embodiments, memory subsystem 126 includes a memory hierarchy that comprises one or more caches coupled to a memory in microfluidic electronic device 100. In some of these embodiments, one or more of the caches is located in processing subsystem 124.

Within microfluidic electronic device 100, components (such as processing subsystem 124 and memory subsystem 126) may be coupled together using bus 132. Bus 132 may include an electrical, optical, and/or electro-optical connection that the subsystems can use to communicate commands and data among one another. Although only one bus 132 is shown for clarity, different embodiments can include a different number or configuration of electrical, optical, and/or electro-optical connections among the subsystems.

Although specific components are used to describe microfluidic electronic device 100, in alternative embodiments, different components and/or subsystems may be present in microfluidic electronic device 100. For example, microfluidic electronic device 100 may include one or more additional processing subsystems and/or memory subsystems. Additionally, one or more of the subsystems may not be present in microfluidic electronic device 100. Moreover, in some embodiments, microfluidic electronic device 100 may include one or more additional subsystems that are not shown in FIG. 1, such as a networking subsystem. Also, although separate subsystems are shown in FIG. 1, in some embodiments, some or all of a given subsystem or component can be integrated into one or more of the other subsystems or component(s) in microfluidic electronic device 100. For example, in some embodiments program module 128 is included in operating system 130.

Moreover, the circuits and components in microfluidic electronic device 100 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Therefore, operations performed during the non-contact printing technique may be performed in the analog and/or the digital domain, as well as in the time domain and/or the frequency domain. Additionally, components and circuits may be single-ended or differential, and power supplies may be unipolar or bipolar.

An integrated circuit may implement some or all of the functionality of microfluidic electronic device 100. Moreover, the integrated circuit may include hardware and/or software mechanisms that are used for non-contact printing.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations performed by microfluidic electronic device 100 may be implemented using a program module 128 stored in memory subsystem 126 that is executed by processing subsystem 124, an operating system 130 (such as a driver for actuator mechanism 110) or in firmware. Alternatively or additionally, at least some of the operations in the non-contact printing technique may be implemented in hardware, such as one or more circuits in an integrated circuit.

The preceding embodiments may include fewer components or additional components. Although these embodiments are illustrated as having a number of discrete items, these embodiments are intended to be functional descriptions of the various features that may be present rather than structural schematics of the embodiments described herein. Consequently, in these embodiments two or more components may be combined into a single component, and/or a position of one or more components may be changed.

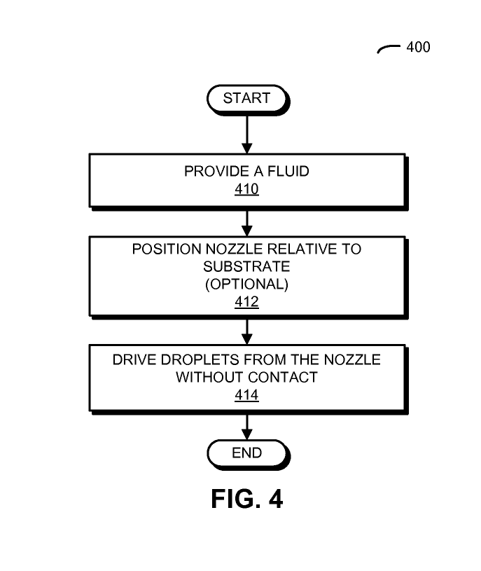

We now describe embodiments of the method. FIG. 4 presents a flow diagram illustrating a method 400 for non-contact printing, which may be performed using a microfluidic electronic device (such as microfluidic electronic device 100 in FIG. 1). During operation, a fluid reservoir in the microfluidic electronic device provides, via a channel, a fluid (operation 410) with a solvent and a material in solution to a nozzle in a microfluidic cartridge. Then, using an actuator mechanism, the microfluidic electronic device drives droplets from the nozzle without contact (operation 414) between the actuator mechanism and the fluid, where the actuator mechanism is separate from the microfluidic cartridge, and where the microfluidic cartridge is remateably coupled to the microfluidic electronic device.

In some embodiments, prior to driving the droplets (operation 414), a positioning mechanism in the microfluidic electronic device optionally positions the nozzle relative to a substrate (operation 412).

In some embodiments of method 400, there are additional or fewer operations. Moreover, the order of the operations may be changed, and/or two or more operations may be combined into a single operation.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an actuator mechanism; and
a cartridge, separate from the actuator mechanism, with a fluid reservoir coupled to a nozzle by a channel, wherein the cartridge is remateably coupled to the electronic device;
wherein the fluid reservoir is configured to hold a fluid with a solvent and a material in solution; and
wherein, during operation of the electronic device:
the cartridge is configured to supply fluid to the nozzle via the channel; and
the actuator mechanism is configured to drive droplets from the nozzle without contact between the actuator mechanism and the fluid.

2. The electronic device of claim 1, wherein the electronic device further includes a substrate; and
wherein, during operation of the electronic device, the droplets are driven from the nozzle onto the substrate without contact between the substrate and the nozzle.

3. The electronic device of claim 2, wherein the electronic device further comprises a positioning mechanism configured to position the nozzle relative to the substrate.

4. The electronic device of claim 1, wherein a geometry of the channel and the nozzle corresponds to a desired size of the droplets.

5. The electronic device of claim 1, wherein the solvent includes one of: water and an organic solvent.

6. The electronic device of claim 1, wherein the material includes one of: deoxyribonucleic acid, ribonucleic acid, a protein, a cell, and a pharmacological agent.

7. The electronic device of claim 1, wherein the cartridge includes multiple layers; and
wherein the cartridge includes a polymer.

8. The electronic device of claim 7, wherein the polymer includes a silicone.

9. The electronic device of claim 1, wherein, during operation of the electronic device, the actuator mechanism drives the droplets using a pin that pushes on a membrane; and
wherein the pin is actuated by one of: an electrostatic force, an electromagnetic force, air pressure, and a piezoelectric material.

10. A cartridge, comprising:
a fluid reservoir configured to hold a fluid with a solvent and a material in solution;
a channel coupled to the fluid reservoir; and
a nozzle, coupled to the channel, wherein the cartridge is configured to supply fluid to the nozzle via the channel;
wherein the cartridge is configured to remateably couple to an electronic device that includes an actuator mechanism; and
wherein, during operation, the cartridge is configured to drive droplets from the nozzle without contact between the actuator mechanism and the fluid.

11. The cartridge of claim 10, wherein a geometry of the channel and the nozzle corresponds to a desired size of the droplets.

12. The cartridge of claim 10, wherein the solvent includes one of: water and an organic solvent; and
wherein the material includes one of: deoxyribonucleic acid, ribonucleic acid, a protein, a cell, and a pharmacological agent.

13. The cartridge of claim 10, wherein the cartridge includes multiple layers; and
wherein the cartridge includes a polymer.

14. An electronic-device-implemented method for non-contact printing, wherein the method comprises:
providing a fluid with a solvent and a material in solution from a fluid reservoir to a nozzle via a channel in a cartridge; and
using an actuator mechanism in the electronic device, driving droplets from the nozzle without contact between the actuator mechanism and the fluid, wherein the actuator mechanism is separate from the cartridge; and
wherein the cartridge is remateably coupled to the electronic device;

15. The method of claim 14, wherein the droplets are driven from the nozzle onto the substrate without contact between the substrate and the nozzle.

16. The method of claim 15, wherein, prior to driving the droplets, the method further comprises positioning the nozzle relative to the substrate.

17. The method of claim 14, wherein a geometry of the channel and the nozzle corresponds to a desired size of the droplets.

18. The method of claim 14, wherein the solvent includes one of: water and an organic solvent; and
wherein the material includes one of: deoxyribonucleic acid, ribonucleic acid, a protein, a cell, and a pharmacological agent.

19. The method of claim 14, wherein the cartridge includes multiple layers; and
wherein the cartridge includes a polymer.

20. The method of claim 14, wherein driving the droplets uses a pin that pushes on a membrane based on one of: an electrostatic force, an electromagnetic force, air pressure, and a piezoelectric material.
